(19) United States
(12) Patent Application Publication
(10) Pub. No.: US 2025/0167863 A1
(43) Pub. Date: May 22, 2025

(54) BEACON SIGNALS FOR BEAM MANAGEMENT AT COVERAGE ENHANCING DEVICE

(71) Applicants: SONY GROUP CORPORATION, Tokyo (JP); SONY EUROPE B.V., Weybridge Surrey (GB)

(72) Inventors: Erik BENGTSSON, Eslöv (SE); Chaitanya TUMULA, Åkarp (SE); Fredrik RUSEK, Eslöv (SE); Jose FLORDELIS, Lund (SE); Ying ZHINONG, Lund (SE); Kun ZHAO, Malmö (SE); Olof ZANDER, Södra Sandby (SE)

(21) Appl. No.: 18/835,202

(22) PCT Filed: Feb. 14, 2023
(86) PCT No.: PCT/EP2023/053679

§ 371 Date: Aug. 1, 2024

(30) Foreign Application Priority Data
Feb. 21, 2022 (SE) 2250232-2

(51) Int. Cl. H04B 7/06; H04B 7/04; H04B 7/155

(52) U.S. Cl. CPC H04B 7/06952; H04B 7/04013; H04B 7/15528

(57) ABSTRACT

Various examples of the disclosure pertain to be management at a coverage enhancing device. A location of a wireless communication device can be detected based on a beacon signal that is emitted by a beacon of the wireless communication device and an appropriate spatial filter can be selected at the coverage enhancing device. Prioritization between different wireless communication devices is possible.

### TECHNICAL FIELD

Various examples of the disclosure generally relate to communicating between nodes using a coverage enhancing device. Various examples relate to facilitating beam management at the coverage enhancing device.

### BACKGROUND

To increase a coverage area for wireless communication, it is envisioned to use coverage enhancing devices (CEDs), particularly re-configurable relaying devices (RRD) or more particularly re-configurable reflective devices. Re-configurable reflective devices are sometimes also referred to as reflecting large intelligent surfaces (LISs). See, e.g., Huang, C., Zappone, A., Alexandropoulos, G. C., Debbah, M., & Yuen, C. (2019). Reconfigurable intelligent surfaces for energy efficiency in wireless communication. IEEE Transactions on Wireless Communications, 18(8), 4157-4170.

A CED can be implemented by an array of antennas that can reflect incident electromagnetic waves/signals. The array of antennas can be semi-passive. Semi-passive can correspond to a scenario in which the antennas can impose a variable phase shift and typically provide no signal amplification. Thereby, a spatial filter including at least one input beam and at least one output beam can be defined. By means of the spatial filter, electromagnetic waves can be steered or generally tailored. Thus, a data radio link (or simply data link) can be supported.

### SUMMARY

Techniques are required for beam management at the coverage enhancing device. Beam management generally pertains to selection of the appropriate spatial filter that includes, e.g., a beam directed towards a wireless communication device in the surrounding of the CED. This need is met by the features of the independent claims. The features of the dependent claims define examples.

A method of operating a wireless communication device includes establishing a data link between the wireless communication device and an access node. The data link is in a second range of the electromagnetic spectrum. The method also includes, upon establishing the data link, monitoring occurrence of a least one trigger event that is associated with the data link. The method further includes, based on said monitoring of the occurrence of the at least one trigger event, conditionally activating a beacon of the wireless communication device to emit a beacon signal. The beacon signal resides in a first range of the electromagnetic spectrum. The first range of the electromagnetic spectrum is different than the second range of the electromagnetic spectrum. By means of the activating of the beacon, support of the data link by a CED in the surrounding of the wireless communication device is requested.

A computer program or a computer program product or a computer-readable storage medium includes program code. The program code can be loaded and executed by at least one processor. Loading and executing the program code causes the at least one processor to perform a method of operating a wireless communication device. The method includes establishing a data link between the wireless communication device and an access node. The data link is in a second range of the electromagnetic spectrum. The method also includes, upon establishing the data link, monitoring occurrence of a least one trigger event that is associated with the data link. The method further includes, based on said monitoring of the occurrence of the at least one trigger event, conditionally activating a beacon of the wireless communication device to emit a beacon signal. The beacon signal resides in a first range of the electromagnetic spectrum. The first range of the electromagnetic spectrum is different than the second range of the electromagnetic spectrum. By means of the activating of the beacon, support of the data link by a CED in the surrounding of the wireless communication device is requested.

A wireless communication device includes a processor configured to establish a data link between the wireless communication device and an access node. The data link is in a second range of the electromagnetic spectrum. The method also includes, upon establishing the data link, monitoring occurrence of a least one trigger event that is associated with the data link. The processor is further configured to include, based on said monitoring of the occurrence of the at least one trigger event, conditionally activating a beacon of the wireless communication device to emit a beacon signal. The beacon signal resides in a first range of the electromagnetic spectrum. The first range of the electromagnetic spectrum is different than the second range of the electromagnetic spectrum. By means of the activating of the beacon, support of the data link by a CED in the surrounding of the wireless communication device is requested.

A method of operating a control node includes obtaining indicators that are indicative of at least one state of multiple data links between multiple wireless communication devices and at least one access node. The data links are in a second range of the electromagnetic spectrum. The multiple wireless communication devices are located in a surrounding of a CED. The method further includes selecting at least one of the multiple data links based on the indicators that are indicative of the at least one state of the multiple data links. The method also includes providing, to a least one wireless communication device of the multiple wireless communication devices that is associated with the selected at least one of the multiple data links, a control command to activate a beacon to emit a beacon signal. The beacon signal is in a first range of the electromagnetic spectrum. The first range of the electromagnetic spectrum is different than the second range. By activating the beacon, support of the selected at least one of the multiple of data links by the CED is requested.

A computer program or a computer program product or a computer-readable storage medium includes program code. The program code can be loaded and executed by at least one processor. Loading and executing the program code causes the at least one processor to perform a method of operating a control node. The method includes obtaining indicators that are indicative of at least one state of multiple data links between multiple wireless communication devices and at least one access node. The data links are in a second range of the electromagnetic spectrum. The multiple wireless communication devices are located in a surrounding of a CED. The method further includes selecting at least one of the multiple data links based on the indicators that are indicative of the at least one state of the multiple data links. The method also includes providing, to a least one wireless communication device of the multiple wireless communication devices that is associated with the selected at least one of the multiple data links, a control command to activate a beacon to emit a beacon signal. The beacon signal is in a first range of the electromagnetic spectrum. The first range of the electromagnetic spectrum is different than the second range. By activating the beacon, support of the selected at least one of the multiple of data links by the CED is requested.

A control node includes a processor configured to obtain indicators that are indicative of at least one state of multiple data links between multiple wireless communication devices and at least one access node. The data links are in a second range of the electromagnetic spectrum. The multiple wireless communication devices are located in a surrounding of a CED. The processor is further configured to select at least one of the multiple data links based on the indicators that are indicative of the at least one state of the multiple data links. The processor is further configured to provide, to a least one wireless communication device of the multiple wireless communication devices that is associated with the selected at least one of the multiple data links, a control command to activate a beacon to emit a beacon signal. The beacon signal is in a first range of the electromagnetic spectrum. The first range of the electromagnetic spectrum is different than the second range. By activating the beacon, support of the selected at least one of the multiple of data links by the CED is requested.

A method of operating a CED for supporting one or more data links between at least one access node and one or more wireless communication devices in a surrounding of the CED includes discovering a first wireless communication device of the one or more wireless communication devices in the surrounding of the CED. Said discovering is by detecting a beacon signal that is emitted by a beacon of the first wireless communication device. The beacon signal resides in the first range of the electromagnetic spectrum. The method further includes, based on the beacon signal, determining a relative location of the first wireless communication device with respect to the CED. The method further includes, responsive to said discovering of the first wireless communication device and based on the relative location, activating a spatial filter to thereby support the data link between the at least one access node and the first wireless communication device in a second range of the electromagnetic spectrum. The second range is different than the first range of the electromagnetic spectrum. The spatial filter includes a beam directed towards the first wireless communication device.

A computer program or a computer program product or a computer-readable storage medium includes program code. The program code can be loaded and executed by at least one processor. Loading and executing the program code causes the at least one processor to perform a method of operating a CED for supporting one or more data links between at least one access node and one or more wireless communication devices in a surrounding of the CED. The method includes discovering a first wireless communication device of the one or more wireless communication devices in the surrounding of the CED. Said discovering is by detecting a beacon signal that is emitted by a beacon of the first wireless communication device. The beacon signal resides in the first range of the electromagnetic spectrum. The method further includes, based on the beacon signal, determining a relative location of the first wireless communication device with respect to the CED. The method further includes, responsive to said discovering of the first wireless communication device and based on the relative location, activating a spatial filter to thereby support the data link between the at least one access node and the first wireless communication device in a second range of the electromagnetic spectrum. The second range is different than the first range of the electromagnetic spectrum. The spatial filter includes a beam directed towards the first wireless communication device. A CED for supporting one or more data links between at least one access node and one or more wireless communication devices in a surrounding of the CED includes a processor. The processor is configured to discover a first wireless communication device of the one or more wireless communication devices in the surrounding of the CED. Said discovering is by detecting a beacon signal that is emitted by a beacon of the first wireless communication device. The beacon signal resides in the first range of the electromagnetic spectrum. The processor is further configured to, based on the beacon signal, determine a relative location of the first wireless communication device with respect to the CED. The processor is further configured to, responsive to said discovering of the first wireless communication device and based on the relative location, activate a spatial filter to thereby support the data link between the at least one access node and the first wireless communication device in a second range of the electromagnetic spectrum. The second range is different than the first range of the electromagnetic spectrum. The spatial filter includes a beam directed towards the first wireless communication device.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system according to various examples.

FIG. 2 schematically illustrates the communication system of FIG. 1 in further detail.

FIG. 3 schematically illustrates a communication system including a CED according to various examples.

FIG. 4 schematically illustrates details of the CED.

FIG. 5 is a signaling diagram according to various examples.

FIG. 6 is a signaling diagram according to various examples.

FIG. 7 is a signaling diagram according to various examples.

FIG. 8 is a signaling diagram according to various examples.

FIG. 9 is a flowchart of a method according to various examples.

FIG. 10 is a flowchart of a method according to various examples.

FIG. 11 is a flowchart of a method according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. At least one of the transmitter node or the one or more receiver nodes can be implemented by an access node of a communications network. At least one of the transmitter node or the one or more receiver nodes can be implemented by a wireless communication device (or terminal or user equipment, UE). In some examples, the wireless communication system can be implemented by a wireless communication network, e.g., a radio-access network (RAN) of a Third Generation Partnership Project (3GPP)-specified cellular network (NW). An access node could be implemented by a RAN base station (BS).

Hereinafter, for the sake of simplicity, various examples will be described with respect to an example implementation of the transmitter node by a BS and the one or more receiver node by UEs—i.e., to downlink (DL) communication; but the respective techniques can be applied to other scenarios, e.g., uplink (UL) communication and/or sidelink communication.

According to various examples, the transmitter node can communicate with at least one of the receiver nodes via a CED. This means, that a data link between the transmitter node and the receiver node or receiver nodes can be supported by the CED. Electromagnetic waves travel via the CED and are affected by a spatial filter of the CED.

The CED may include an antenna array. The CED may include a meta-material surface. In examples, a CED may include a reflective antenna array (RAA).

There are many school-of-thoughts for how CEDs should be integrated into 3GPP-standardized RANs.

In an exemplary case, the NW operator has deployed the CEDs and is therefore in full control of the CED operations. The UEs, on the other hand, may not be aware of the presence of any CED, at least initially, i.e., it is transparent to a UE whether it communicates directly with the BS or via a CED. The CED essentially functions as a coverage-extender of the BS. The BS may have established a control link with the CED. There may also be a dedicated control node for controlling the CED via a respective control link.

According to another exemplary case, it might be a private user or some public entity that deploys the CED. Further, it may be that the UE, in this case, controls CED operations. The BS, on the other hand, may not be aware of the presence of any CED and, moreover, may not have control over it/them whatsoever. The UE may gain awareness of the presence of CED by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the CED.

In a further exemplary case, neither the UE nor the BS are aware of the presence of the CED. The CED may be transparent with respect to a communication between the UE and the BS on a data radio channel. The CED may gain awareness of the UE and/or the BS and re-configure itself based on information obtained from the UE and/or BS. In such a scenario, autonomous operation of the CED is possible.

The three exemplary cases described above are summarized in TAB. 1 below.

TABLE 1
Scenarios for CED deployment.

| Scenario | Description | Explanation |
|---|---|---|
| A | BS-CED | A control node, e.g., a BS, controls the |
| | control link | CED and/or can obtain information from |
| | | the CED. A control link is established |
| | | between the BS and the CED. |
| B | UE-CED | UE controls the CED and/or can obtain |
| | control link | information from the CED. A control link |
| | | is established between the UE and the CED. |
| C | transparent | CED re-configures itself based on information |
| | CED | obtained from the UE and/or BS. No control |
| | | link is established between the CED and the |
| | | UE or the BS or another control node. |

Hereinafter, techniques will be disclosed which facilitate beam management at the CED. Specifically, the beam management can include activating or deactivating certain spatial filters.

As a general rule, a spatial filter is characterized by the particular one or more input beams and/or one or more output beams. A spatial filter can be characterized by a particular setting of the reconfigurable elements of the CED, e.g., by a specific setting of the antenna elements.

For example, beam management can be implemented in order to activate or deactivate certain spatial filters that offer high-quality communication between the BS and one or more UEs. For instance, spatial filters may be activated or deactivated to thereby support different data links, i.e., data links between at least one BS and different UEs.

According to various examples, it is, in particular, possible to implement beam management according to any one of scenarios A-C of TAB. 1.

Specifically, beam management at the CED can be implemented in the scenario C according to TAB. 1. Autonomous operation of the CED is thereby facilitated. No additional control link between the CED and other remote nodes, e.g., a BS or a control node or the UE, may be required. This reduces complexity of the CED deployment.

According to various examples, it is possible to use a beacon signal emitted by a beacon of a UE that is located in the surrounding of the CED.

Various options are available for the beacon signal.

As a general rule, an out-of-band beacon signal can be used. This means that the beacon signal is not residing in the same frequency range of the electromagnetic spectrum as the data link.

For instance, an optical beacon signal may be used, i.e., using electromagnetic waves in the wavelength spectrum of light, e.g., in the infrared regime, far-infrared regime, near-infrared regime, visible-light regime or the ultraviolet regime. A visual beacon signal of an active visual marker may be used. For instance, a radiofrequency beacon signal may be used, e.g., at frequencies between 500 MHz and 4 or 5 GHz. A beacon signal in the mmWave or THz spectrum can be used. For instance, a Bluetooth or Wi-Fi beacon signal may be used. An active radio-frequency marker can be used. LIDAR pulses as an example of an optical beacon signal could be used. RADAR pulses could be used.

Beacon signals may be transmitted by the UEs without obeying channel access restrictions. Beacon signals may be transmitted by the UEs without need for allocating specific time-frequency resources on a carrier prior to transmission of the beacon signals—even though the UE may transmit in certain timeslots, e.g., defined in accordance with a time-division multiplex (TDM) switching scheme. Beacon signals may be transmitted without a need of performing a listen-before-talk or clear-channel assessment procedure.

Beacon signals may be transmitted without a need of previously establishing a control link on which the beacon signals can be transmitted. Beacon signals may be transmitted adhoc.

Beacon signals may or may not encode data. For instance, for a visual beacon signal, an on-off-modulation could be used. The amplitude of the beacon signal could be modulated. Thus, data can be read based on decoding the beacon signals.

To detect a beacon signal, a CED may search for certain predetermined patterns of the beacon signal. For instance, a certain pulse pattern and/or a certain wavelength would be conceivable.

The CED may continuously monitor for beacon signals, i.e., repeatedly attempt to detect beacon signals. I.e., the CED may perform blind detection of beacon signals, i.e., without being restricted to specific time resources. For instance, a camera may be used to detect a light signature of beacon signals residing in the light spectrum and the stream of camera images may be continuously checked for the presence of beacon signals. Specifically, it is possible that the CED has no prior knowledge regarding the presence of a UE that can potentially transmit a beacon signal. The CED may discover a UE and its surrounding by detecting the beacon signal. This is in contrast to techniques where the CED would receive prior notification regarding potential presence of the UE, e.g., by setting up a control link with the UE.

Based on the beacon signals, the CED may not only discover a UE, but also be capable of determining a relative location of the UE that transmits the beacon signal. Based on the beacon signals, it would alternatively or additionally to determining the relative location also be possible to determine a relative direction to which the UE transmits the beacon signal.

For instance, the CED may determine an angle-of-arrival of the beacon signal. It would also be possible that the location of the UE is encoded into the beacon signal, i.e., the beacon signal can encode data that indicates the location, e.g., relatively to the CED or in absolute coordinates. A camera may be used to locate the beacon based on the beacon signal. A position sensitive device may be used.

Based on this relative location, the CED may then activate an appropriate spatial filter to thereby support a data link between the BS and the respective UE.

The spatial filter can, specifically, include a beam that is directed towards the UE that transmits the beacon signal.

As a general rule, the spatial filter can be conditionally activated, depending on whether the beacon signal is on or off. In other words, upon detecting a beacon signal, the spatial filter may be activated and remain activated, e.g., until switch-off of the beacon signal is detected. I.e., activating and deactivating a spatial filter may correlate with discovering a UE by detecting a beacon signal and detecting disappearance of the beacon signal, respectively. To do so, the CED may monitor the presence of the beacon signal and then based on said monitoring determine that the beacon signal has disappeared. Responsive to such determining of the disappearance of the beacon signal, the spatial filter may be deactivated.

Sometimes, a scenario may occur where—upon activating a spatial filter for supporting a given data link—another UE is discovered in the surrounding of the CED, because the other UE also emits a respective beacon signal. Then, responsive to such discovering of the other UE, and based on determining a respective relative location of the other UE based on its beacon signal, the CED may deactivate the previously used spatial filter that supports the data link of the initially discovered UE; and may rather activate another spatial filter to support the data link of the later-discovered UE. Thus, in other words, another spatial filter may be activated to switch from supporting the initially supported data link to supporting another data link. Such operation is only one example. Other examples would also include using a multi-device spatial filter that includes multiple beams that are directed towards multiple UEs; or alternatingly activating multiple spatial filters for supporting different data links using a TDM switching scheme. All such strategies fall within coordinating support of multiple data links; further examples and details will be discussed later on.

When a spatial filter is not activated, the CED may be in a power-off state. In a power-off state, there may be no phase coherent operation of multiple antenna elements of the CED, so that no well-defined spatial filter is applied. For example, it would be possible that the power consumption of the CED and the power-off state is significantly lower than the power consumption of the CED when activating a spatial filter.

Responsive to determining a disappearance of the beacon signal, a previously activated spatial filter may be deactivated.

There could be some hysteresis introduced. For instance, the spatial filter may be deactivated upon expiry of a timer that is initialized when the disappearance of the beacon signal is determined. Thereby brief, temporary interruptions of the detection of the beacon signal—e.g., due to obstructions—may be compensated for. Stable operation can be ensured.

Such conditional activation of the spatial filter can enable the UE conditionally requesting support of its data link using the beacon signal. For instance, it would be possible that upon establishing a data link the UE monitors at least one trigger event associated with that data link and, based on said monitoring of occurrence of the at least one trigger event, conditionally activates its beacon to emit the beacon signal.

Thereby, on demand support of the data link by the CED can be requested. This means that sometimes the UE can prefer not having support of the data link by the CED and sometimes the UE can prefer having support of the data link by the CED. For instance, sometimes the link quality may suffice even without support of the data link by the CED.

As a general rule, various trigger events for conditionally requesting support of the data link by emitting the beacon signal would be possible.

For instance, UE-centric trigger events would be possible. Such UE-centric trigger events could be autonomously monitored by the UE. Alternatively or additionally, non-UE-centric trigger events could be used. Here, the decision-making on whether a trigger event occurs may reside at a remote node, e.g., the BS or a control node of the CED.

At least one trigger event could be based on a link state of the data link.

For instance, one conceivable trigger event can include degradation of a link quality of the data link below a predetermined threshold.

As a general rule, the link quality of the data link may be defined with respect to a received signal strength at the UE and/or the BS. Jitter may be considered. A bit error rate or packet error rate could be considered. A signal-to-noise ratio of reference signals communicated on the data link could be considered. The rank of the data link, i.e., number of independent data streams could be considered.

As a general rule, such link quality of the data link—being one of various possible implementations of a trigger event for conditionally requesting support of the data link by the CED—may be determined at the UE or the BS or at a control node. It would be possible that the link quality is assessed by sounding the data link. This can be based on reference signals that are communicated between the BS and the UE. For instance, uplink reference signals and/or downlink reference signals may be used. For instance, a control node may request the BS to request the UE to sound the data link.

A further conceivable trigger event includes obtaining, at the UE, an indication indicative of the degradation of the link quality. For instance, the BS may indicate to the UE that the link quality has degraded below the predetermined threshold. This could also be indicated by a control node associated with the CED. Responsive to receiving such indication, the UE may then activate the beacon to emit the beacon signal.

More generally, it would also be possible to receive an explicit control command to activate the beacon to thereby transmit the beacon signal. For instance, a control node that is associated with operation of the CED—while still not maintaining an active control link towards the CED—may provide such control command to the UE. The control node, as a general rule, may be implemented by a functionality of the BS or may reside as a function at a separate device. In such a scenario, the reason for the control command to activate the beacon may be transparent to the UE. It may not be necessarily linked to the link quality of the data link falling below a predetermined threshold.

For example, the control command could be indicative of a certain time duration for activating the beacon signal. For instance, the control command could be indicative of time slots of a TDM switching scheme during which the UE is to activate the beacon signal.

Using such central coordination of the activation of the beacon signal may be helpful in order to coordinate support of multiple data links associated with different UEs by a central node, e.g., a control node or the BS.

An example of a UE-centric trigger event would, e.g., include uplink data scheduled for transmission to the BS on the data link. For instance, it would be possible to monitor a buffer fill level of a transmission buffer, e.g., on Layer 1 or Layer 2 or Layer 3 of the transmission protocol stack for communicating on the data link. When uplink data is scheduled for transmission, this may serve as a trigger event to request support of the data link by the CED. Thereby, timely delivery of the data by making use of the services of the CED may be facilitated.

Another example for a UE-centric trigger event may include a mobility level of the UE. For instance, where the UE detects a comparably large mobility level—e.g., based on sensor readings of an acceleration sensor or based on absolute positioning data, e.g., obtained through a satellite-navigation system—it may activate its beacon to emit the beacon signal to thereby request support of the data link by the CED. Such techniques are based on the finding that in case of a comparably large mobility level it is likely that the beam management at the CED needs to readjust beams towards the UE.

Another example of a UE-centric trigger event may include an activity of an application supported by a data service that is implemented on the data link. For example, it would be conceivable that a virtual-reality application is implemented which relies on data communicated via the data link. Sometimes, more data may be required to execute the virtual reality application than at other times. This can be due to increased activity of the application. Then, such increased activity may trigger the request for support of the data link via the CED.

Examples of applications that can rely on a data service include video streaming (e.g., uplink video streaming), e.g., at a sports venue. Video streaming for broadcast are conceivable. Several cameras can be connected to multiple UEs and deployed around the venue. CEDs are also deployed in the area of the venue. At any given time, only one camera has the “focus” and needs to stream video with high quality and low latency. Other cameras are in “standby” and can do with lower streaming rates and higher latencies. The focus camera, then, can activate a beacon signal to obtain service from the CED(s).

Such logic residing at the UE to activate the beacon to transmit the beacon signal may be implemented by an application that is executed at a process of the UE. For instance, an Application-layer application may be executed. Such application may be associated with a data service that is implemented on the data link, e.g., a virtual-reality application. The application may monitor the occurrence of the at least one trigger event and may activate the beacon to emit the beacon signal. The occurrence of the at least one trigger event, on the other hand, may be determined based on a notification provided to the application by a lower layer of a transmission protocol stack associated with communicating on the data link and responsible for establishing the data link. For instance, a notification may be provided from Layer 1 (physical layer) or Layer 2 (e.g., medium access layer) or Layer 3 (e.g., radio resource control). Such notifications could be, e.g., indicative of a buffer fill level or another state parameter of communicating on the data link.

Such UE-centric control of the activation of the beacon to emit the beacon signal has the advantage of link robustness and the time needed to acquire a beam for supporting the data link by the CED. Where the trigger event or trigger events are at least partly UE-centric, such latency can be further reduced.

Nonetheless, there can be certain scenarios that benefit from a central coordination of UEs requesting support of the data link by means of beacon signals emitted by beacons of the UEs.

For instance, it is possible that the capability of the CED to support a multi-device spatial filter is limited. This means that it is possible that the CED may also, at a given point in time, support only a count of N data link(s), where, e.g., N=1 or N=2 typically. A spatial filter that includes a single beam directed towards a single UE can be referred to as single-device spatial filter. A spatial filter that includes multiple beams directed to multiple UEs can be referred to as multi-device spatial filter (this could also be referred to as beam splitting).

Where the amount of data links to be supported is larger than N, the CED may alternatingly activate different spatial filters to thereby alternatingly support different data links—this can be in accordance with a TDM switching scheme; however, a given spatial filter may only include one or more beams directed to N UE(s).

Then, by centrally coordinating emission of the beacon signals, it is possible to prioritize the support of the CED between multiple UEs and multiple data links, respectively.

Different decision criteria can underlie such a prioritization. For instance, it would be possible to obtain, at a control node, indicators that are indicative of at least one state of multiple data links that are between multiple UEs and at least one BS. Then, at least one of those multiple data links can be selected based on these indicators. Depending on this selection, a control command to activate a respective beacon to emit a beacon signal may be provided to at least one UE that is associated with the selected at least one data link.

For instance, such at least one state of the data link could include the link quality of the data links. For instance, one or more measurement reports—e.g., according to one or more quality metrics—may be provided to the control node. Then, the control node may, e.g., prioritize those data link or data links that experience a comparatively low link quality.

The rationale behind this would be that such data links that experience a comparatively low link quality would particularly benefit from the support by the CED. Such a prioritization could take, e.g., the form of more often activating a respective spatial filter or respective spatial filters for the prioritized data links.

Other states of the data link can include, e.g., the mobility level of the UEs or UL or DL data scheduled for transmission on the respective data links. The amount of UL or DL data could be considered. The quality-of-service requirements of UL or DL data could be considered.

In some scenarios, a decision can be taken by the control node to support two or more data links. Then, a respective control command to activate respective beacons to emit beacon signals can be provided to two or more UEs associated with those 2 or more data links.

In such scenario, either a multi-device spatial filter can be used at the CED—e.g., upon detecting multiple beacon signals emitted by multiple UEs; or a TDM switching scheme may be used.

For instance, the control command may prompt the two or more UEs to alternatingly activate their respective beacons in accordance with the TDM switching scheme.

For instance, at a first point in time, one or more first UEs may emit beacon signals and at the second point in time one or more second UEs may emit beacon signals. The one or more first UEs and the one or more second UEs may then be alternatingly discovered by the CED. Respective spatial filters may be alternatingly activated. The CED does not require prior knowledge of the TDM switching scheme.

For instance, the TDM switching scheme can be indicated by means of the control command to the involved UEs. This would, e.g., include notifying the UEs of specific timeslots during which the beacon signals are to be emitted. For instance, it would be possible to rely on a timing reference provided by the BS to define such timeslots of the TDM switching scheme. By such a technique, a single control command to be provided to the involved UEs would be sufficient to trigger the various UEs to switch on and switch off the beacon signal multiple times.

The indicators indicative of the at least one state of one or more data links could be obtained from the BS and/or from the UEs.

For instance, UEs could execute an application that communicates directly with the control node and pass on such information.

In some examples, it would be possible that the indicators are at least partially obtained from the CED. The CED may have a control link established with the control node through which it can provide such reporting. For instance, it would be possible that the CED at least partially decodes signals communicated on the data links. Based on such decoding, it would be possible to determine such indicators.

In some scenarios, the indicators could be further indicative of one or more identities of the multiple UEs. For instance, it would be possible that the indicators are indicative of device-specific unique identities associated with the UEs. Examples would include, e.g., the International Mobile Subscriber Identity (IMSI). Alternatively or additionally, it would be possible that the indicators are indicative of identities assigned to the UEs in association with the respective data links. For instance, different data links could be defined on Layer 3 of the transmission protocol stack and could be characterized by respective identities. Such identities could be signaled.

Based on such identities, it would be possible to direct the control commands to the specific UEs. It would also be possible to generate authentication credentials that are UE-specific based on such identities. Such authentication credentials could be provided to the UEs to be encoded into the beacon signal. Such authentication credentials may also be based on a secret/secure information that is known to the CED, so that the CED can validate the authentication credentials.

Above, scenarios have been described in which a coordination of support of the CED for multiple data links is centrally implemented at the control node. The control node can perform a selection of at least one data link to be supported. Some data links may remain unsupported by the CED, upon a respective decision by the control node.

It is not required in all scenarios that such a central coordination of support is implemented at the control node. For instance, support could also be coordinated at the CED itself.

In other words, it would be possible that the CED prioritizes between supporting different data links. This could be based on data that is encoded into the beacon signal. More generally, based on such data encoded into the beacon signal, the CED may determine whether to activate a respective spatial filter or not, or specifically may determine when to activate a respective spatial filter.

To give a concrete example of such prioritization, initially, the CED may discover a given UE based on detecting a respective beacon signal that is emitted by that UE. The CED may then activate a respective spatial filter, e.g., by transitioning from a power-off state. Then, while this spatial filter associated with the given UE is activated, the CED may discover another UE by detecting a respective beacon signal that is emitted by that other UE. Instead of deactivating the spatial filter associated with the initial the discovered given UE, the CED may read data encoded into the beacon signal emitted by the given UE and further data encoded into the beacon signal emitted by the other UE. This data could be indicative of the link states of the respective data links of the given UE and the other UE. The CED could then perform a comparison between those link states and prioritize between activation of the spatial filter to support the data link that is associated with the given UE or the spatial filter that is associated with the data link of the other UE. Such prioritization could either mean that only one of the two spatial filters is activated. Such a prioritization could also mean that a given one of the two spatial filters is activated more often and/or for longer durations and/or at larger duty cycles.

As will be appreciated from the above, based on data encoded into the beacon signal, it is possible to convey information to the CED that enables the CED to make decisions regarding prioritization of supporting different data links. The CED can perform a selection of one or more data links to be supported. Thus, such logic can be shifted from a central control node (respective scenarios have been disclosed above) to the CED (as described here). Also combinations are possible, e.g., where the central control node makes a pre-selection and the CED makes a finer selection.

This is only one option for making use of data encoded into the beacon signals. Other options are conceivable.

For example, it would be possible to determine whether to activate a spatial filter for a given UE depending on a link state of a data link associated with that UE (i.e., also irrespective of whether one or more further UEs are discovered based on further beacon signals). For example, the link state may include a link quality of the data link or may include an indication of whether uplink data is scheduled for transmission to BS. Other examples of the link state could include, e.g., UE mobility level, etc., as already discussed above. Only if one or more predetermined criteria with respect to the link state are fulfilled, the CED may activate a respective spatial filter or consider a respective spatial filter to be activated (e.g., subject to prioritization over other candidate spatial filters to be activated, as explained above).

In another example of using data encoded into the beacon signals, data encoded into the beacon signal may include at least one of an identity of the CED, an identity of the UE, or authentication credentials of the UE. For instance, by determining whether the beacon signal encodes the identity of the CED or credentials, authorization of the UE to request support of its associated data link by the CED may be verified. Further, it would be possible to distinguish between multiple CEDs that serve a common area. Similarly, the CED may have access to a list of candidate UEs for which data links would be supported. It would be possible to match the identity of the UE to the entries of that list. It would be possible to implement an authentication of the UE that it emits a beacon signal. For instance, authentication credentials may be verified.

For example, it would be possible that such data is matched to one or more predetermined reference data. Then, the spatial filter can be conditionally activated depending on a result of such matching.

The predetermined reference data may be hardcoded into the CED. The predetermined reference data may be stored in a local memory of the CED. It would be possible that the predetermined reference data is obtained from the control node via a control link between the CED and the control node.

In yet another example of using data encoded into the beacon signals, the value of an operating parameter of the CED may be set based on such data. It would be possible that one or more states of the data link or specifically the UE are indicated by the data; accordingly, the CED may conditionally activate the spatial filter and/or set operating properties based on such information.

For example, upon activating a spatial filter, operation of the CED may be set in accordance with the value of an operating parameter that is included in the data encoded into the beacon signal. For instance, such operating parameter can include a signal gain of the spatial filter, e.g., where signal amplification or damping is available as a functionality of the CED. Alternatively or additionally, such operating parameter could include a beam width or another spatial beam characteristic of the beam that is directed to the UE. It would also be possible that the data includes the TDM switching scheme for activating the spatial filter. For instance, by means of such data that is encoded into the beacon signal, it would be possible to signal, to the CED, certain time slots during which a given spatial filter including a beam directed to a given UE is to be activated. The beacon signal could also signal a timing reference associated with such timeslots. I.e., the beacon signal could provide for synchronization, e.g., by flashing or generally amplitude modulation. Alternatively or additionally, the operating parameter could include a phase shift of the spatial filter. For instance, the spatial filter could globally shift the phase of incident wavefront of electromagnetic waves used to carry signals along the data link.

Further examples and details with respect to such beam management strategies at the CED based on beacon signals detected from UEs in its surrounding will become apparent from the drawings described hereinafter.

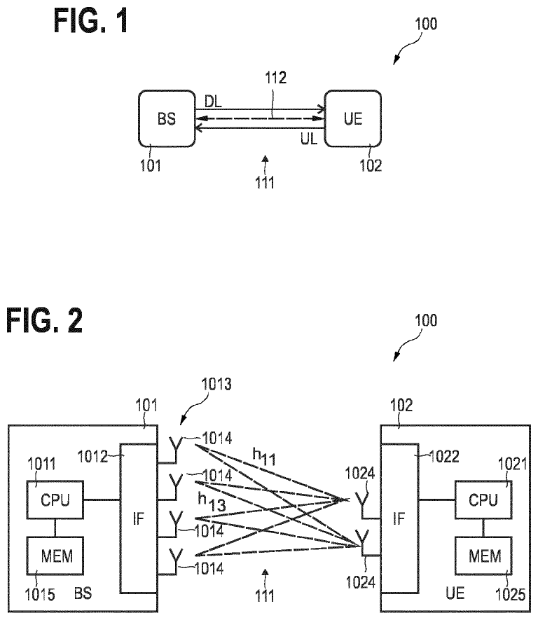

FIG. 1 schematically illustrates a communication system 100. The communication system includes two nodes 101, 102 that are configured to communicate with each other via a data carrier 111. In the example of FIG. 1, the node 101 is implemented by an access node, more specifically a BS, and the node 102 is implemented by a UE. The BS 101 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by a BS 101 of a cellular NW and a UE 102.

As illustrated in FIG. 1, there can be DL communication, as well as UL communication. Various examples described herein particularly focus on the DL communication from the BS 101 to the UE 102. However, similar techniques may be applied to UL communication from the UE 102 to the BS 101.

The UE 102 and the BS 101 can communicate on the data carrier 111. For instance, the data carrier 111 may have a carrier frequency of not less than 20 GHz or even not less than 40 GHz. The data carrier 111 may be via a CED (not illustrated in FIG. 1).

Specifically, a data link 112 can be implemented on the data carrier 111. The data link 112 can include one or more logical channels that define a time-frequency resource grid. The data link 112 can be established, e.g., based on a random-access procedure of the UE 102, e.g., responsive to paging.

FIG. 2 illustrates details with respect to the BS 101. The BS 101 implements an access node to a communications network, e.g., a 3GPP-specified cellular network. The BS 101 includes control circuitry that is implemented by a processor 1011 and a non-volatile memory 1015. The processor 1011 can load program code that is stored in the memory 1015. The processor 1011 can then execute the program code. Executing the program code causes the processor to perform techniques as described herein, e.g.: transmitting and/or receiving (communicating) payload data on the data link 112 on the data carrier 111, e.g., via a CED (not shown in FIG. 2); sounding a quality of the data link; controlling a CED; commanding UEs to detect beacon signals; etc.

FIG. 2 also illustrates details with respect to the UE 102. The UE 102 includes control circuitry that is implemented by a processor 1021 and a non-volatile memory 1025. The processor 1021 can load program code that is stored in the memory 1025. The processor can execute the program code. Executing the program code causes the processor to perform techniques as described herein, e.g.: transmitting and/or receiving (communicating) payload data on the data link 112 on the data carrier 111, e.g., via a CED (not shown in FIG. 2); sounding a quality of the data link; selectively activating or deactivating a beacon to emit a beacon signal to thereby request support of the data ink by the CED; encoding data into the beacon signal; etc.

FIG. 2 also illustrates details with respect to communication between the BS 101 and the UE 102 on the data carrier 111. The BS 101 includes an interface 1012 that can access and control multiple antennas 1014. Likewise, the UE 102 includes an interface 1022 that can access and control multiple antennas 1024.

While the scenario of FIG. 2 illustrates the antennas 1014 being coupled to the BS 101, as a general rule, it would be possible to employ transmit-receive points (TRPs) that are spaced apart from the BS.

The interfaces 1012, 1022 can each include one or more TX chains and one or more receiver chains. For instance, such RX chains can include low noise amplifiers, analogue to digital converters, mixers, etc. Analogue and/or digital beamforming would be possible. Thereby, phase-coherent transmitting and/or receiving (communicating) can be implemented across the multiple antennas 1014, 1024. Multi-antenna techniques can be implemented.

By using a TX beam, the direction of signals transmitted by a transmitter of the communication system is controlled. Energy is focused into a respective direction or even multiple directions, by phase-coherent superposition of the individual signals originating from each antenna 1014, 1024. Thereby, a spatial data stream can be directed. The spatial data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

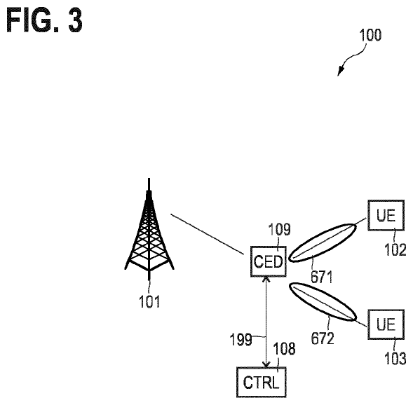

FIG. 3 illustrates aspects with respect to communicating via a—CED 109. Two UEs 102, 103 are served by the BS 101 via a CED 109. Different steering vectors define beams 671-672 that are directed to the UE 102 and the UE 103, respectively. A spatial filter can address one of those two steering vectors or sometimes also both steering vectors. Each UE 102, 103 can be served by the BS 101 using one or more respective spatial data streams between the BS 101 and the CED 109 (the spatial data streams are not illustrated in FIG. 3 for the sake of simplicity).

Also illustrated in FIG. 3 is a control node 108 that can communicate with the CED 109 on a control link 199. The control node 108 is generally optional, cf. TAB. 1, scenario C. While the control node 108 is shown as a separate device, it would be possible that the control node 108 is implemented as the functionality of the BS 101. The control node may be co-located with the CED 109.

In some scenarios, a control node 108 may also indirectly communicate with the CED 109, e.g., by communicating with the BS 101 and/or the UEs 102, 103 (this communication is not shown in FIG. 3).

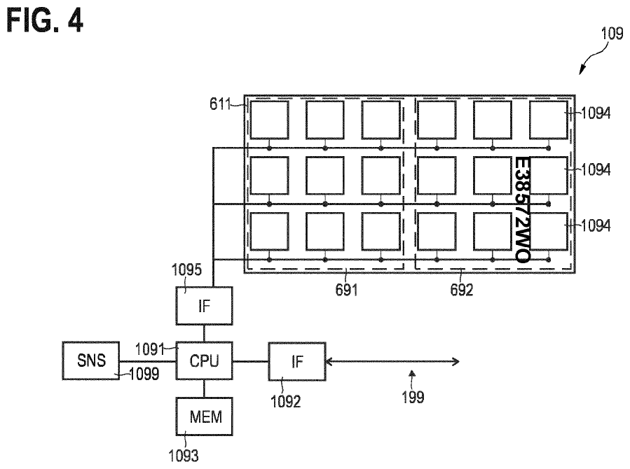

FIG. 4 illustrates aspects in connection with the CED 109. The CED 109 includes an array of REs 1094—e.g., antennas or meta-material unit cells—each imposing a respective configurable phase shift when reflecting incident electromagnetic waves; this defines a respective spatial filter. The array of REs 1094 in the illustrated example is passive; i.e., the REs 1094 may not be able to change the amplitude of the electromagnetic waves. This array of REs 1094 forms a reflective surface 611. Typically, antennas can impose gradually varying phase shifts; while meta-material unit cells may, in some examples, be configured to provide only a set of phase shifts with a higher degree of quantization if compared to antennas, e.g., a either one of two phase shifts, e.g., such as +90° or −90° or 0° and +180° (“1-bit setting”).

Each RE 1094 can locally provide a respective phase shift, i.e., each RE 1094 may be individually configured.

The (re-)configuration of REs 1094 defines respective spatial filters that are associated with spatial directions into which incoming electromagnetic waves are reflected, i.e., on a macroscopic level. This defines the spatial direction into which an outgoing beam 671-672 (cf. FIG. 3) is reflected.

The CED 109 includes an antenna interface 1095 and a processor 1091 that can activate respective spatial filters one after another.

Further, there is a communication interface 1092 such that communication on a control link 199 can be established between the CED 109 and a remote node, e.g., the BS 101 or the control node 108 (cf. FIG. 3). Example implementations of the control link 199 include, e.g., a Wi-Fi protocol or a Bluetooth protocol. Out-of-band signaling may be used with respect to the communication of payload data on the data link via the REs. The control link 199 could also be implemented using the same communication protocol used for communication payload data; e.g., a separate bandwidth part may be used for the control link 199. In-band signaling may be used. Different bandwidth parts may be used for the communication of payload data via the REs and the auxiliary link. A wired connection would be possible. The control link 199 can be used to assist the beam management procedure at the CED 109.

The processor 1091 can load program code from a non-volatile memory 1093 and execute the program code. Executing the program code causes the processor to perform techniques as described herein, e.g.: re-configuring each one of the REs 1094 to activate one of multiple spatial filters, e.g., in accordance with a TDM switching scheme; discovering UEs in the surrounding based on beacon signals that are detected (for this, the processor 1091 may have access to a respective sensor 1099, e.g., a camera); decoding beacon signals to read data; etc.

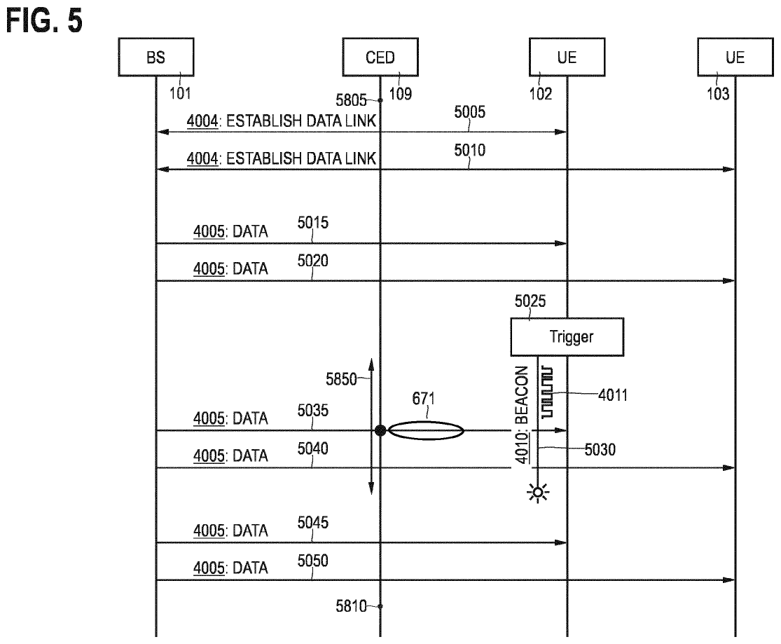

FIG. 5 is a signaling diagram of communication between the BS 101, the UE 102, and the UE 103. A CED 109 can be used to support respective data links.

At 5005, a data link 112 is established between the BS 101 and the UE 102. The CED 109 is not involved. The CED 109 does not yet have knowledge of presence of the UE 102 in its surrounding.

At 5010, another data link is established between the BS 101 and the UE 103. The CED 109 is not involved. The CED 109 does not yet have knowledge of presence of the UE 103 in its surrounding.

As a general rule, establishing a data link can include a random-access procedure and Radio Resource Control signaling.

Subsequently, at 5015, DL data 4005 is transmitted by the BS 101 and received by the UE 102 on the data link 112 established between the BS 101 and the UE 102.

At 5020, DL data 4005 is transmitted by the BS 101 and received by the UE 103 on the respective data link established between the BS 101 and the UE 103. The CED 109 is not involved.

The UE 102 and the UE 103, upon establishing the data link, monitor for occurrence of a trigger event associated with the data links.

At 5025, the UE 102 detects a trigger event and then activates a beacon to emit a beacon signal 4010, at 5030.

The CED 109 continuously monitors for beacon signals 4010 between points in time 5805 and 5810. A respective sensor is used that has a certain field of view that defines the surrounding within which UEs may be discovered.

Accordingly, the CED 109 detects the beacon signal 4010 and, based on that beacon signal, discovers the UE 102. Prior to this, the CED 109 need not to have knowledge of the presence of the UE 102 and the UE 103 in its surrounding.

The CED 109 then determines the relative location of the UE 102 based on the beacon signal 4010 and uses this relative location to activate a spatial filter to thereby support the data link 112 between the BS 101 and the UE 102. This spatial filter is then used to forward data 4005 communicated on this data link 112 between the BS 101 and the UE 102 at 5035; the respective beam 671 of that spatial filter that is directed towards the UE 102 is illustrated in FIG. 5.

Data 4005 that is transmitted by the BS 101 at 5040 to the UE 103 on the respective data link is not forwarded by the CED 109, because a respective spatial filter is not activated.

The spatial filter for supporting the data link 112 between the BS 101 and the UE 102 remains activated throughout a time duration 5850. During the time duration 5850, the CED 109 monitors presence of the beacon signal 4010 and eventually determines, based on said monitoring, that the beacon signal 4010 disappears. This is responsive to the UE 102 switching off the beacon. This can have various reasons, e.g., the trigger event for which occurrence has been determined at 5025 is no longer valid.

Then, the spatial filter is deactivated. Further data 4005 that is transmitted by the BS 101 at 5045 and at 5050 is not via the CED 109.

For example, it would be possible that the CED 109 operates in a power-off state before and after the time duration 5850.

As illustrated in FIG. 5, the beacon signal may encode data 4011. This is generally optional.

For example, the CED 109 may read data 4011 that is encoded into the beacon signal 4010 and match the data to one or more predetermined reference data. It would then be possible that the spatial filter is conditionally activated to support the data link 112 between the BS 101 and the UE 102 depending on a result of this matching. For instance, such data for 4011 could include an identity of the CED 109, and/or an identity of the UE 102, and/or authentication credentials of the UE 102. Predetermined reference data could be provided to the CED 109 from a control node, e.g., implemented by the BS 101, on a respective control link. Such conditional activation may avoid unauthorized use of the CED 109 and/or selection, by the UE 102, between multiple CEDs by encoding the desired CED identity.

Alternatively or additionally, such data 4011 could also include a value of an operating parameter of the CED 109, e.g., a signal gain, a beam width, or a TDM switching scheme for activating the spatial filter, or a phase shift of the spatial filter. The CED 109 may accordingly set its operation based on such value.

For instance, where the TDM switching scheme is indicated, the respective spatial filter including the beam 671 may only be activated during respective timeslots; other timeslots may be used for activating other spatial filters (not shown in FIG. 5).

Sometimes, the data 4011 could also include a link state of the data link 112 between the BS 101 and the UE 102. For instance, the link state could include the link quality and/or an indication of UL data that is scheduled for transmission to the BS 101. Based on such link state, the CED 109 may judge whether to activate the spatial filter for supporting the data link 112 between the BS 101 and the UE 102. For instance, if the link state is healthy, the CED 109 could refrain from activating the spatial filter and, e.g., remain in a power-off state to save energy.

As a general rule, various trigger events to be monitored by the UE 102 are conceivable. Examples would include a degradation of a link quality of the data link 112 between the BS 101 and the UE 102 below a predetermined threshold.

As a general rule, UE-centric and network-centric trigger events may be considered.

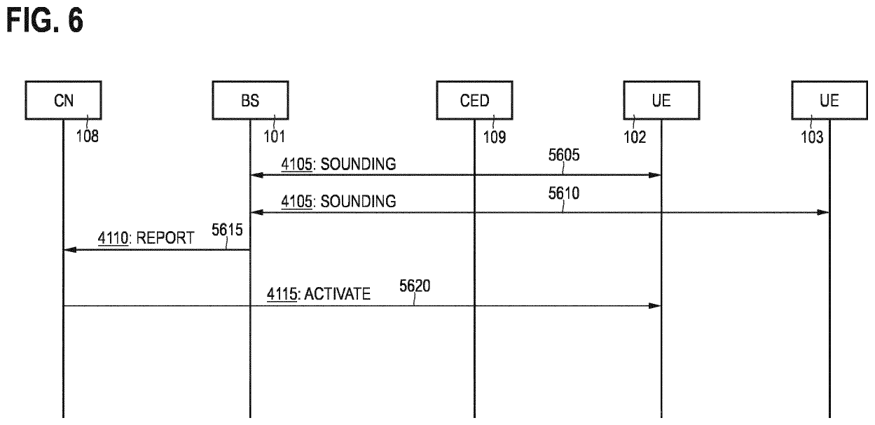

A respective example of a network-centric trigger event—here also based on the link quality of the data link 112 between the BS 101 and the UE 102—is illustrated in FIG. 6.

FIG. 6 is a signaling diagram of communicating between the CN 108, the BS 101, and the UEs 102, 103.

Here, at 5605 and 5610, channel sounding is implemented for the data links between the BS 101 and the UE 102 and the BS 101 and the UE 103, respectively. This can involve communicating UL reference signals 4105 and/or DL reference signals 4105 in the frequency range of the data links. It would be possible that such channel sounding is commanded by the control node 108 (not illustrated in FIG. 6).

The BS can provide a report 4110, i.e., indicators indicative of the link state, e.g., the link quality of the respective data links 112, to the control node 108, at 5615.

Alternatively or additionally to such link quality that is obtained through channel sounding, the link state could also pertain to, e.g., a mobility level of the UEs 102, 103 or whether UL data or DL data is scheduled for transmission on the respective data links 112.

The control node 108 can then select the data link 112 between the BS 101 and the UE 102 based on these indicators that are indicated of the link states (rather than the data link between the BS 101 and the UE 103); and provide, to the UE 102, a control command 4115 to activate its beacon to emit the beacon signal 4010, at 5620.

FIG. 6 only illustrates one example of implementing channel sounding to determine the link quality. Sometimes, the UEs 102, 103 could directly report, on a higher layer, to the CN 108 the link quality of provide an associated measurement report based on monitoring downlink reference signals transmitted by the BS 101. This could be transparent to the BS 101.

Sometimes, the control command 4115 could convey further information, e.g., authentication credentials, an identity of the CED 109, and/or timeslots during which the UE 102 is allowed to activate its beacon signal, e.g., in accordance with a TDM switching scheme.

By using the control node 108, contemporaneous activation of beacons at multiple UEs can be avoided. Thus, the CED 109 does not need to select between multiple discovered UEs.

The scenario of FIG. 6 involves the central control node 108. The UE 102 obtains, from the control node 108, an indication indicative of the degradation of the link quality or more generally the link state. The command 4115 could also be implemented as a specific prompt to activate the beacon (i.e., without reasons given). Thus, the logic at the UE can be restricted to detecting the control command 4115 and switching on the beacon.

In other scenarios, monitoring of the occurrence of a UE-centric trigger event would be possible. For instance, the UE 102 could judge, based on DL reference signals, locally whether to activate or not activate the beacon, i.e., without involvement of the control node 108. Likewise, the UE could locally monitor whether UL data is scheduled for transmission or it could locally monitor its mobility level. Here, latency can be reduced between, e.g., degradation of link state and requesting support from the CED 109.

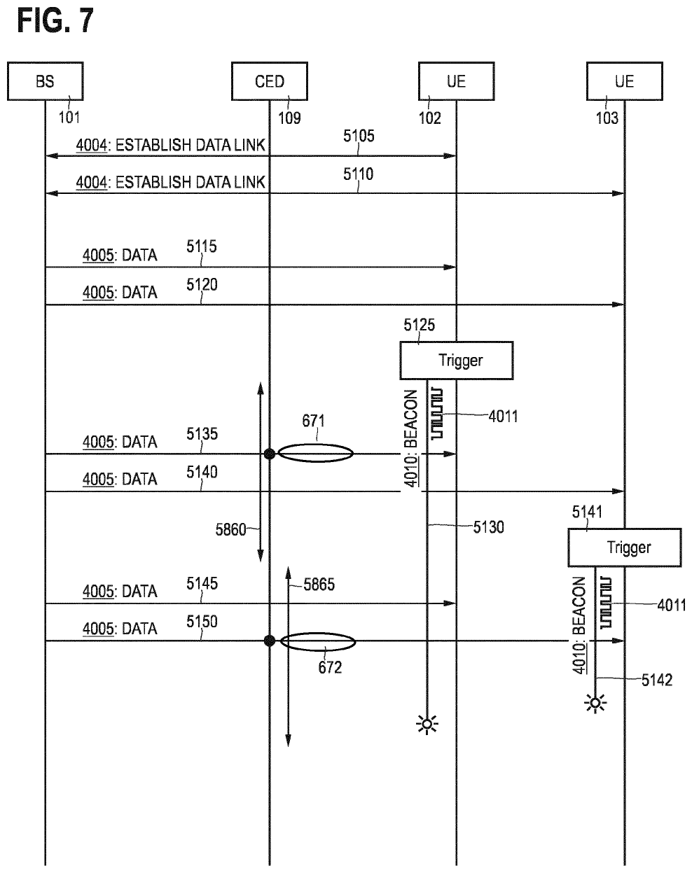

Such locally monitoring of occurrence of the trigger event, on the other hand, can lead to a scenario in which multiple UEs contemporaneously request support of their data links by means of the beacon signal. Such a scenario illustrated in FIG. 7.

FIG. 7 is a signaling diagram that generally corresponds to the signaling diagram of FIG. 5.

Specifically, 5105 corresponds to 5005; 5110 corresponds to 5010; 5115 corresponds to 5015; 5120 corresponds to 5020.

At 5125, the UE 102 determines occurrence of a trigger event and, accordingly, activate its beacon so that the beacon signal 4010 is emitted. This could be, specifically, determining occurrence of a UE-centric trigger event (albeit generally also a control command 4115 could be received, cf. FIG. 6).

The CED 109 discovers the UE 102 and detects the beacon signal 4010 emitted at/during 5130 and accordingly, during the time duration 5860, activates the spatial filter including the beam 671 to support the data link:

Then, 5135 corresponds to 5035; and 5140 corresponds to 5040.

Then, in the scenario of FIG. 7, at 5141 the UE 103 detects occurrence of a trigger event (UE-centric or network-centric) and, accordingly, activates its beacon so that the beacon signal 4010 is emitted at/during 5142.

The CED 109 thus discovers the UE 103 by detecting the beacon signal 4010 that is emitted by the beacon of the UE 103. The CED 109 then determines the relative location of the UE 103 with respect to the CED 109 and responsive to detecting the UE 103 deactivates the spatial filter including the beam 671; and instead activates the spatial filter that includes the beam 672, to thereby support the data link 112 between the BS 101 and the UE 103.

In some scenarios, such deactivation of the spatial filter that includes the output beam 671 directed towards the UE 102 to thereby activate the spatial filter including the beam 672 directed to the UE 103 may be based on a respective prioritization. For instance, the CED 109 may compare link states encoded into the data 4011 of the beacon signals 4010 emitted by the UE 102 at the UE 103, respectively; and based on such comparisons decide that the data link 112 between the BS 101 and the UE 103 is to be prioritized over the data link 112 between the BS 101 and the UE 102.

Thus, at 5145, DL data 4005 is transmitted by the BS 101 and received by the UE 102, wherein this DL data 4005 transmitted at 5145 does not go via the CED 109. Differently, at 5150, the BS 101 transmits DL data 4005 that goes via the CED 109 to the UE 103.

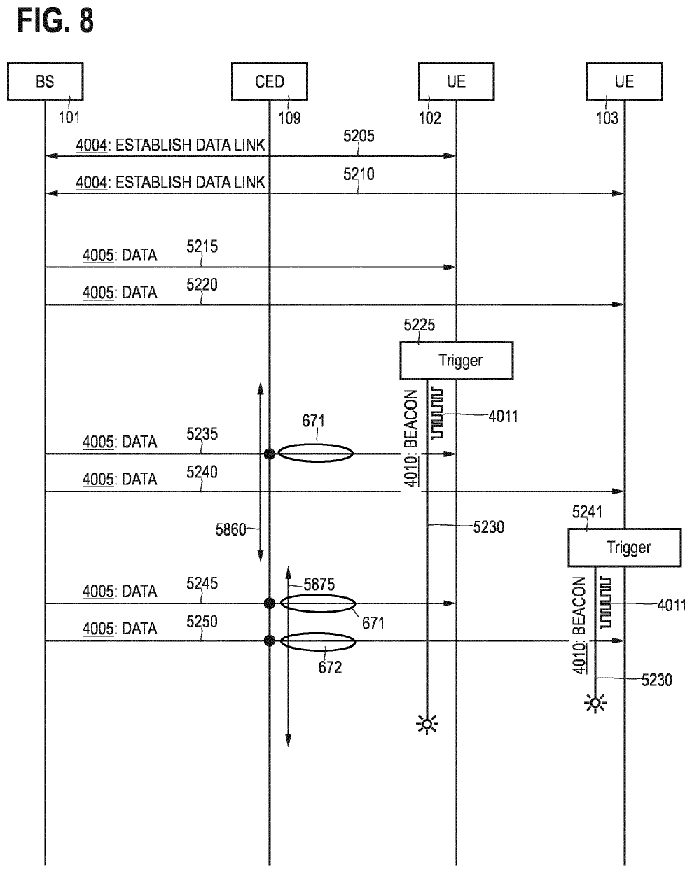

Sometimes, it may not be required to select between data links of UEs that contemporaneously emit beacon signals. Rather, the CED 109 may support multiple data links using beam splitting. Such a scenario is illustrated in FIG. 8.

FIG. 8 generally corresponds to FIG. 7.

Specifically, 5205 corresponds to 5105; 5210 corresponds to 5110; 5215 corresponds to 5115; 5220 corresponds to 5120; 5225 corresponds to 5125; 5230 corresponds to 5130; 5235 corresponds to 5135; 5240 corresponds to 5140; 5241 corresponds to 5141.

Then, during a time duration 5875, a multi-device spatial filter is activated by this CED 109 that includes both beams 671, 672 directed to both UEs 102, 103. Thereby, it is possible to support both data links 112 between the BS 101 and the UE 102, as well as between the BS 101 and the UE 103 concurrently.

In a further variation of the signaling diagrams of FIG. 7 and FIG. 8, it would be possible that the CED 109 switches between different spatial filters in accordance with a TDM switching scheme, while detecting multiple beacon signals 4010.

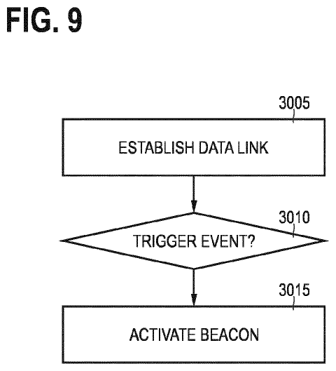

FIG. 9 is a flowchart of a method according to various examples. The method of FIG. 9 can be executed by a UE, e.g., by the UE 102 or the UE 103. The method of FIG. 9 can be executed by a processor upon loading program code from a memory and executing the program code. For example, the method of FIG. 9 could be executed by the processor 1021 upon loading and executing program code from the memory 1025. The method of FIG. 9 can be executed by a processor that executes an application, e.g., defined on Application layer of a transmission protocol stack.

At box 3005, a data link is established between the UE and a BS. This has been discussed in connection with signaling 4004 above.

Then, upon establishing the data link, the UE can monitor for occurrence of at least one trigger event at box 3010. Respective aspects have been discussed in connection with 5025, 5125, 5141, 5225, and 5241 above.

Responsive to detecting occurrence of a trigger event, the UE can conditionally activate a beacon to emit a beacon signal, at box 3015. The beacon signal may encode data. Aspects of the beacon signal have been discussed above in connection with the beacon signal 4010 and the data 4011.

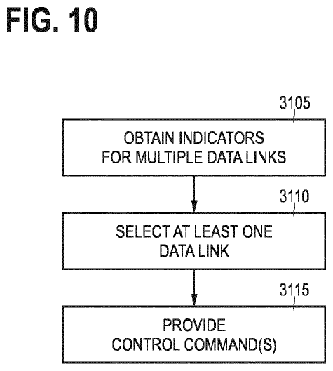

FIG. 10 is a flowchart of a method according to various examples. The method of FIG. 10 can be executed by a control node such as the control node 108. The control node could be, in some scenarios, implemented by a BS such as the BS 101. The method of FIG. 10 can be executed by a processor upon loading program code from a memory and executing the program code. For example, the method of FIG. 10 could be executed by the processor 1011 upon loading and executing program code from the memory 1015.

At box 3105, indicators for multiple data links are obtained. These indicators are indicative of link states of the multiple data links. Respective aspects have been discussed in connection with the report message 4110 in FIG. 6.

The indicators could be, as a general rule, obtained from a BS and/or a UE. in addition to being indicative of link states—e.g., link quality, mobility level, amount of data scheduled for transmission, urgency of data scheduled for transmission and so forth—it would be possible that these indicators are also indicative of identities of respective UEs that communicate on the data links.

Then, at box 3110, at least one data link of the multiple data links for which indicators are obtained, can be selected. This could be based on the prioritization. It would also be possible to individually consider the link state of each individual data link. Authorization could be considered based on UE identities.

Then, at box 3115, depending on the selection at box 3110, one or more control commands are provided to the UEs to activate respective beacons to emit beacon signals. Such control commands have been discussed in connection with signaling 4115 in FIG. 6.

For instance, where multiple UEs are commanded to activate the beacons, the control commands could be indicative of a respective TDM switching scheme, so that the multiple UEs alternatingly activate the beacons.

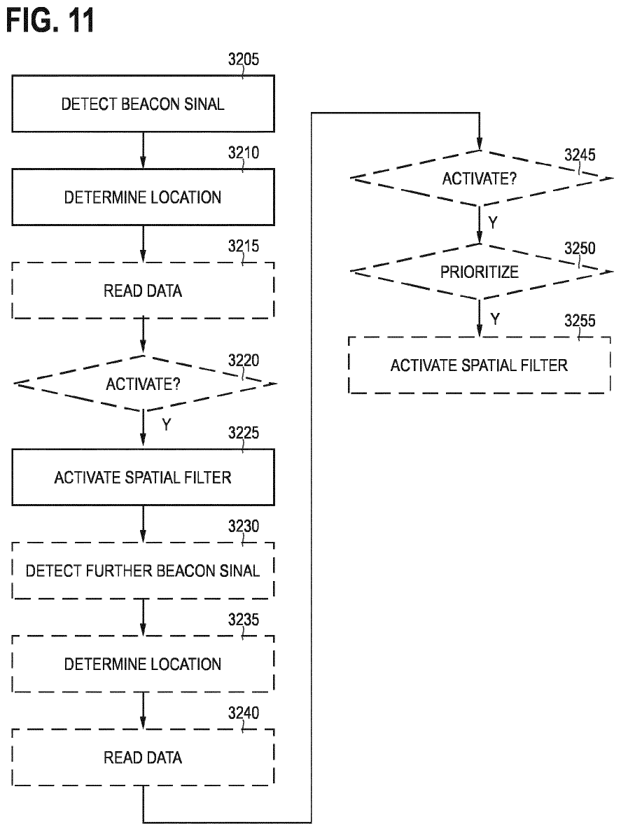

FIG. 11 is a flowchart of a method according to various examples. The method of FIG. 11 can be executed by a CED, e.g., the CED 109. For instance, the method of FIG. 9 can be executed by the processor 1091 upon loading program code from the memory 1093 and executing the program code. Optional boxes are labeled with dashed lines.

At box 3205, a beacon signal emitted by a UE in the surrounding is detected, e.g., using an appropriate sensor.

Then, based on the beacon signal, at box 3210, the relative location of the UE with respect to the CEDs determined. Object detection could be performed. Angle-of-arrival measurements are possible. A position sensitive device may be used.

It would be optionally possible, at box 3215 to read data that is encoded into the beacon signal, e.g., using an on-off-modulation or amplitude modulation.

Then, where such data is read, at box 3220, it could be decided whether to proceed, based on such data. For instance, such data could be compared against reference data, e.g., to determine an authorization of the UE to request the services of the CED or to determine whether the CEDs the intended recipient of the beacon signal.

If the method continues, then, at box 3225, the spatial filter is activated that includes a beam that is directed towards the UE. “Directed towards the UE” can mean that this beam is suitable to support the respective data link, i.e., increasing quality metrics. Directed towards the UE does not necessarily only encompass such beams that directly point towards the UE, but can also include reflections (line-of-sight and non-line-of-sight).

In some scenarios, it would be optionally possible to detect a further beacon signal at box 3230 emitted by a further UE, then determine the location of that further UE at box 3235, optionally read data from that further UE at box 3240, determine whether to activate a respective spatial filter at box 3245. These boxes correspond to boxes 3205-3225.

Optionally, at box 3250, it could be judged whether one of the spatial filters directed towards the different UEs is to be prioritized. If the spatial filter associated with the newly discovered UE is to be prioritized, then, at box 3255 the respective spatial filter can be activated.

Summarizing, techniques have been disclosed that facilitate beam management at CEDs. These techniques rely on beacon signals, e.g., visual beacon signals of an active visual marker or radio-frequency beacon signals of a radio-frequency marker. Their activation may be centrally controlled. Alternatively or additionally, the CED can decide which UE and data link is to be supported.

For instance, using the techniques disclosed herein, the following scenario may be implemented. A communication system may include a BS in a fixed position and a number of UEs. The communication system further comprises at least one CED connected to a server implementing a control node. In each of the UEs there is an application running and the application repeatedly reports a quality metric (received signal strength indicator, rate, signal-to-noise, or rank etc.) on a higher layer to the control node. The application in the UE is further capable of giving a visual indication (e.g., activating/deactivating a light-emitting diode) based on a triggering control command from the control node. I.e., a beacon signal can be emitted. The CED is further equipped with a co-allocated camera and an associated algorithm susceptible to the visual indication. The control node, having access to the quality metric from all connected UEs, may select at least one UE. The control node then configures the selected UE to activate the visual indicator, which will then be detected by the CED camera. The CED is configured with the angle toward the BS (which is assumed to be fixed and known), and based on the detection of the visual beacon signal, the CED computes an angle toward a UE and configure its reflection according to the angle pair. I.e., the appropriate spatial filter can be activated. In some examples the beacon signal may encode pulses (or other identification) to ensure that e.g., other lights e.g., in a factory, are not confusing the algorithm. In some examples, a destination identity can also be encoded into the beacon signal (e.g., signaling through LED, infrared, etc.), where the destination identity identifies one of several CEDs within the field of vision of the visual beacon, and for which the message is intended. In a further example, the pulse pattern (or e.g color of LED) can be used to send messages to the CED, e.g., a value of an operating parameter/configurations of RIS such as to turn off active amplification, change mode to beam splitting (supporting multiple beams directed towards multiple UEs), wider beam etc. In a further example, the beam selection algorithm (the actual intelligence) is run in the CED and the beacon signals can encode a quantity of the quality metric, e.g. by pulse patterns or color/wavelength of LED. In this example, the control node processes the quality metric and configures the UEs. In one example, a control node is not used and the UEs directly activate the beacon signal and the algorithm is entirely run in the CED.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, scenarios have been described in which the beacon signal is in electromagnetic signal. Alternatively, examples would include audio-based beacon signals, e.g., an echo emitted by the CED could be analyzed. The UE could also generate an active sound beacon signal. The audio signal may be ultrasound or in the hearing spectrum.

For further illustration, scenarios have been disclosed in which a CED discovers UEs in its surrounding by detecting beacon signals that are actively emitted by a beacon of those UEs. In some scenarios, UEs may not include an active beacon; rather, the CED could scan its surrounding, e.g., using LIDAR, RADAR or camera-based object detection and localization.

1. A method of operating a wireless communication device, the method comprising:
establishing a data link between the wireless communication device and an access node in a second range of the electromagnetic spectrum,
upon establishing the data link: monitoring an occurrence of at least one trigger event associated with the data link, and
based on said monitoring of the occurrence of the at least one trigger event: conditionally activating a beacon of the wireless communication device to emit a beacon signal, the beacon signal residing in a first range of the electromagnetic spectrum that is different than the second range of the electromagnetic spectrum, to thereby request support of the data link by a coverage enhancing device in a surrounding of the wireless communication device.

2. The method of claim 1,
wherein the at least one trigger event comprises a degradation of a link quality of the data link below a predetermined threshold.

3. The method of claim 2, further comprising:
sounding the data link based on reference signals communicated between the access node and the wireless communication device in the second range of the electromagnetic spectrum, to thereby determine the link quality.

4. The method of claim 2, further comprising:
obtaining, from a remote node, an indication indicative of the degradation of the link quality.

5. The method of claim 1,
wherein the at least one trigger event comprises obtaining, from a remote node, a control command to activate the beacon.

6. The method of claim 1,
wherein the at least one trigger event comprises uplink data scheduled for transmission to the access node on the data link.

7. The method of claim 1,
wherein the at least one trigger event comprises a mobility level of the wireless communication device.

8. The method of claim 1, further comprising:
executing, at a processor of the wireless communication device, an application to execute said monitoring of the occurrence of the at least one trigger event and said activating of the beacon to emit the beacon signal,
wherein the occurrence of the at least one trigger event is determined based on a notification provided to the application by a lower layer of a transmission protocol stack for establishing the data link.

9. A method of operating a control node, the method comprising:
obtaining indicators indicative of at least one state of multiple data links between multiple wireless communication devices and at least one access node, the data links being in a second range of the electromagnetic spectrum, the multiple wireless communication devices being located in a surrounding of a coverage enhancing device,
selecting at least one of the multiple data links based on the indicators indicative of the at least one state of the multiple data links, and
providing, to at least one wireless communication device of the multiple wireless communication devices that is associated with the selected at least one of the multiple data links, a control command to activate a beacon to emit a beacon signal in a first range of the electromagnetic spectrum that is different than the second range, to thereby request support of the selected at least one of the multiple data links by the coverage enhancing device.

10. The method of claim 9,
wherein the at least one state comprises a link quality of the multiple data links.

11. The method of claim 9,
wherein the at least one state comprises a mobility level of the multiple wireless communication devices.

12. The method of claim 9,
wherein the at least one state comprises at least one of uplink data or downlink data scheduled for transmission on the multiple data links.

13. The method of claim 9,
wherein the at least one wireless communication device 102, 103) comprises two or more wireless communication devices of the multiple wireless communication devices,
wherein the control command is provided to the two or more wireless communication devices to alternatingly activate the beacons at the two or more wireless communication devices in accordance with a time-division multiplexing switching scheme.

14. The method of claim 13,
wherein the control command is indicative of the time-division multiplexing switching scheme.

15. The method of claim 9,
wherein the indicators are at least partially obtained from the at least one access node.

16. The method of claim 9,
wherein the indicators are further indicative of one or more identities of the multiple wireless communication devices.

17. The method of claim 9,
wherein the indicators are at least partially obtained from the multiple wireless communication devices or the coverage enhancing device.

18. The method of claim 9,
wherein the beacon signal comprises a visual beacon signal of an active visual marker of the wireless communication device.

19. The method of claim 9,
wherein the beacon signal comprises a radio-frequency beacon signal of an active radio-frequency marker of the wireless communication device.

20. A method of operating a coverage enhancing device for supporting one or more data links between at least one access node and one or more wireless communication devices in a surrounding of the coverage enhancing device,
wherein the method comprises:
discovering a first wireless communication device of the one or more wireless communication devices in the surrounding of the coverage enhancing device by detecting a beacon signal emitted by a beacon of the first wireless communication device, the beacon signal residing in a first range of the electromagnetic spectrum,
based on the beacon signal, determining a relative location of the first wireless communication device with respect to the coverage enhancing device, and
responsive to said discovering of the first wireless communication device and based on the relative location, activating a spatial filter to thereby support the data link between the at least one access node and the first wireless communication device in a second range of the electromagnetic spectrum that is different than the first range of the electromagnetic spectrum, the spatial filter comprising a beam directed towards the first wireless communication device.

21-38. (canceled)
